(19) United States
(12) Patent Application Publication
(10) Pub. No.: US 2025/0252311 A1
(43) Pub. Date: Aug. 7, 2025

(54) SYSTEM AND METHOD FOR ADAPTATION OF CONTAINERS FOR FLOATING-POINT DATA FOR TRAINING OF A MACHINE LEARNING MODEL

(71) Applicant: THE GOVERNING COUNCIL OF THE UNIVERSITY OF TORONTO, Toronto (CA)

(72) Inventors: Milos NIKOLIC, Toronto (CA); Enrique TORRES SANCHEZ, Zaragoza (ES); Jiahui WANG, Toronto (CA); Andreas MOSHOVOS, North York (CA)

(21) Appl. No.: 18/856,408

(22) PCT Filed: Apr. 18, 2023
(86) PCT No.: PCT/CA2023/050524

§ 371 Date: Oct. 11, 2024

Related U.S. Application Data
(60) Provisional application No. 63/363,288, filed on Apr. 20, 2022.

(51) Int. Cl. G06N 3/084; G06N 3/0499

(52) U.S. Cl. CPC G06N 3/084; G06N 3/0499

(57) ABSTRACT

Provided is a system and method for adaptation of containers for floating-point data for training of a machine learning model. The method includes: receiving training data for training the machine learning model; determining adapted mantissa bitlengths for the floating point data used to store activations or weights of the training data, the adapted mantissa bitlengths are determined independent of the bitlengths of the exponents of the floating point data; and storing the floating point data with the adapted mantissas for training the machine learning model.

### TECHNICAL FIELD

The following relates, generally, to deep learning; and more particularly, to a system and method for adaptation of containers for floating-point data for training of a machine learning model.

### BACKGROUND

Training neural networks has generally become an exascale class task requiring many graphics processors or specialized accelerators. The need for energy efficient and fast inference further increases training costs as additional processing is needed during training to best tune the resulting neural network. Techniques such as quantization, pruning, network architecture search, and hyperparameter exploration are examples of such training-time tuning techniques. The need for improving training speed and energy efficiency is not limited to server-class installations. Such approaches are generally desirable at the “edge”, where training can be used to refine an existing model with user-specific information and input.

In some cases, distributed training reduces training time by exploiting model, data, and pipeline parallelism. Dataflow optimizations, such as data blocking and reuse, and communication and computation overlapping, improve performance and energy efficiency by best allocating and using compute, memory and communication resources within and across computing nodes. Transfer learning can reduce training time and customization of a neural network by utilizing another previously trained network as the basis upon which to train a refined model. Regardless of whether training is done using a single node or is distributed across several, such as in federated and distributed learning, single node performance and energy efficiency remains critically important.

### SUMMARY

In an aspect, there is provided a computer-implemented method for adaptation for data of a machine learning model, the data of the machine learning model comprising floating point data, and a training dataset, the method comprising receiving the training dataset for training the machine learning model; determining adapted mantissa bitlengths for the floating point data used to store activations or weights of the model, the adapted mantissa bitlengths being determined independent of the bitlengths of exponents of the floating point data; and storing the floating point data with the adapted mantissas for training the machine learning model.

In a particular case of the method, determining adapted mantissa bitlengths comprises determining integer mantissa bitlengths in a forward pass of training of the machine learning model and determining integer mantissa bitlengths and non-integer mantissa bitlengths in the backward pass of training of the machine learning model.

In another case of the method, the training comprises gradient descent.

In yet another case of the method, determining the integer mantissa bitlengths comprises integer quantization of the mantissa by removing all but a top predetermined number of bits.

In yet another case of the method, the machine learning model comprises a modified loss function that penalizes mantissa bitlengths by adding a weighted average of bits required for weights and activations of the mantissa bitlengths.

In yet another case of the method, determining adapted mantissa bitlengths comprises splitting training into a plurality of conceptual periods and adjusting the mantissa bitlengths at the end of each period based on network progress in the preceding period.

In yet another case of the method, the network progress is determined using an exponential moving average of a training loss over the preceding period.

In yet another case of the method, the mantissa bitlength is reduced if the training loss is less than the exponential moving average, the mantissa bitlength is maintained if the training loss is equal to the exponential moving average, and the mantissa bitlength is increased if the training loss is greater than the exponential moving average.

In yet another case of the method, the method further comprising determining adapted exponent bitlengths for floating point data used to store activations or weights of the model's data, the adapted exponent bitlengths are determined independent of the determination of the adapted mantissa bitlengths of the floating point data, and further comprising storing the floating point data with the adapted exponent bitlengths for training the machine learning model.

In yet another case of the method, determining the adapted exponent bitlengths comprises grouping the exponents of the floating point data and determining the adapted exponent bitlengths for each group comprises determining differences from a base exponent value per group.

In yet another case of the method, the base exponent value is a first value of the group or a fixed pre-determined number.

In yet another case of the method, the adapted exponent bitlengths for each group comprise a number of bits to store a largest difference to the base exponent value in the group.

In yet another case of the method, the method further comprising learning exponent bitlengths for floating point data of the model during forward passes and backward passes of training using gradient descent, and limiting the exponent bitlengths to the learned bitlengths.

In another aspect, there is provided a system for adaptation of data of a machine learning model, the data of the machine learning model comprising floating point data, and a training dataset, the system comprising one or more processors and a data storage, the one or more processors configurable to execute an input module to receive the training dataset for training the machine learning model; a mantissa module to determine adapted mantissa bitlengths for the floating point data used to store activations or weights of the model data, the adapted mantissa bitlengths being determined independent of the bitlengths of the exponents of the floating point data; and an output module to store the floating point data with the adapted mantissas for training the machine learning model.

In a particular case of the system, determining adapted mantissa bitlengths comprises determining integer mantissa bitlengths in a forward pass of training of the machine learning model and determining integer mantissa bitlengths and non-integer mantissa bitlengths in the backward pass of training of the machine learning model.

In another case of the system, the training comprises gradient descent.

In yet another case of the system, determining the integer mantissa bitlengths comprises integer quantization of the mantissa by removing all but a top predetermined number of bits.

In yet another case of the system, the machine learning model comprises a modified loss function that penalizes mantissa bitlengths by adding a weighted average of bits required for weights and activations of the mantissa bitlengths.

In yet another case of the system, determining adapted mantissa bitlengths comprises splitting training into a plurality of conceptual periods and adjusting the mantissa bitlengths at the end of each period based on network progress in the preceding period.

In yet another case of the system, the network progress is determined using an exponential moving average of a training loss over the preceding period.

In yet another case of the system, the mantissa bitlength is reduced if the training loss is less than the exponential moving average, the mantissa bitlength is maintained if the training loss is equal to the exponential moving average, and the mantissa bitlength is increased if the training loss is greater than the exponential moving average.

In yet another case of the system, the system further comprising an exponent module to determine adapted exponent bitlengths for floating point containers used to store activations or weights of the models data, the adapted exponent bitlengths are determined independent of the determination of the adapted mantissa bitlengths of the floating point data, and wherein the output module further stores the floating point data with the adapted exponent bitlengths for training the machine learning model.

In yet another case of the system, determining the adapted exponent bitlengths comprises grouping the exponents of the floating point containers and determining the adapted exponent bitlengths for each group comprises determining differences from a base exponent value per group.

In yet another case of the system, the base exponent value is a first value of the group or a fixed pre-determined number.

In yet another case of the system, the adapted exponent bitlengths for each group comprise a number of bits to store a largest difference to the base exponent value in the group.

In yet another case of the system, the system further comprising an exponent module to learn exponent bitlengths for floating point data of the model during forward passes and backward passes of training using gradient descent, and limiting the exponent bitlengths to the learned bitlengths.

In yet another aspect, a computer-implemented method for training a machine learning model using a training dataset is provided, the method comprising: receiving the training data; transforming the machine learning model's floating point data to have adapted bitlengths for mantissa, exponent, or both, to produce a transformed model; storing the adapted bitlengths for the machine learning model; training the transformed machine learning model with the training dataset.

In a particular case of the method, a previously trained machine learning model is retrained with a second training dataset, and wherein the retraining is performed by transforming the model to have floating point data transformed with the adapted bitlengths.

In another case of the method, the adapted bitlengths are permitted to vary for each layer and tensor of the machine learning model.

In yet a further aspect, a computer-implemented method for adaptation of a machine learning model's data is provided, the model's data comprising fixed point data, and a training dataset, the method comprising: receiving the training data for training the machine learning model; determining adapted bitlengths for the fixed point data used to store activations or weights of the model's data; and storing the fixed point data with the adapted mantissas while training the machine learning model.

These and other aspects are contemplated and described herein. It will be appreciated that the foregoing summary sets out representative aspects of the system and method to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram illustrating an example training process and memory transfers, where numbers represent equations that are computed; shown are activations that are saved to off-chip memory during forward pass and retrieved during backward pass, weights that are stored and loaded once from off-chip memory, updates and gradients, through mini-batching during the backward pass they can often fit on-chip;

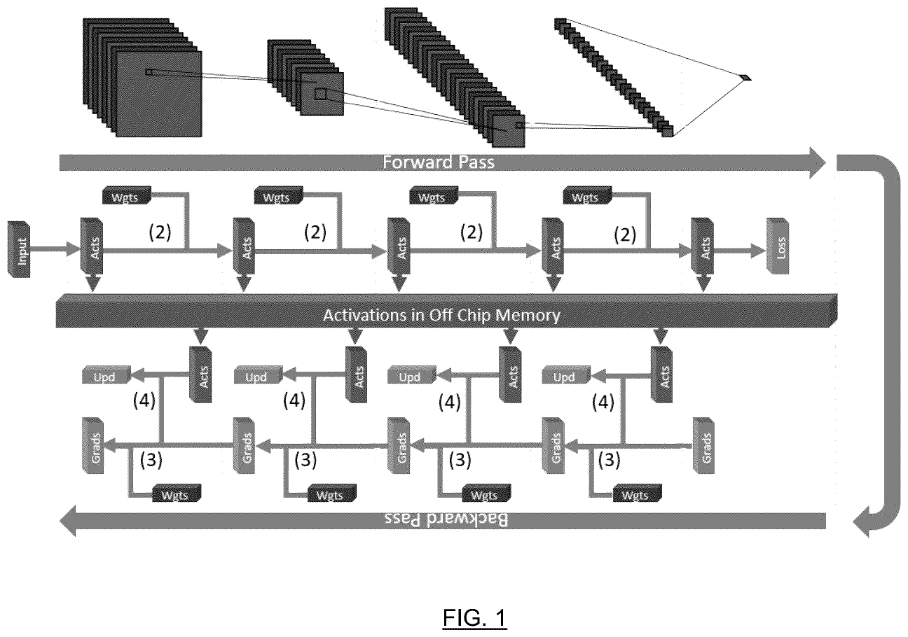

FIG. 2 is a chart showing ResNet18 validation accuracy throughout training using the present embodiments;

FIG. 3 is a chart showing ResNet18 weighted mantissa bitlengths with their spread throughout training than a weighted average using the present embodiments;

FIG. 4 is a chart showing mantissa bitlengths for each layer of ResNet18 at the end of each epoch, where darker dots represent the latter epochs, using the present embodiments;

FIG. 5 is an illustration showing and observe/decide approach, using the present embodiments;

FIG. 6 is a chart showing ResNet18/ImageNet validation accuracy throughout BFloat16 training, using the present embodiments;

FIG. 7 is a chart showing ResNet18 average mantissa bitlengths per epoch throughout training, on BFloat16 and FP32, using the present embodiments;

FIG. 8 is a chart showing distribution of mantissa bitlengths throughout 5005 batches of epoch 45 in ImageNet training, using the present embodiments;

FIG. 9 is a chart showing distribution of exponent values, using the present embodiments;

FIG. 10 is a chart showing post-encoding distribution of exponent bitlength, using the present embodiments;

FIG. 11A is a diagram showing an example compressor, using the present embodiments;

FIG. 11B is a diagram showing an example decompressor, using the present embodiments;

FIG. 11C is a diagram showing an example packer, using the present embodiments;

FIG. 11D is a diagram showing an example unpacker, using the present embodiments;

FIG. 12 is a chart showing relative training footprint of FP32, BF16, SFP_{BC} and SFP_{QM};

FIG. 13 is a chart showing a comparison of cumulative activation footprint with BF16, sparsity only, and GIST++ compression;

FIG. 14 is a diagram showing a system for adaptation of training data for training of a machine learning model, in accordance with an embodiment; and

FIG. 15 is a flowchart showing a method for adaptation of training data for training of a machine learning model, in accordance with an embodiment.

### DETAILED DESCRIPTION

Embodiments will now be described with reference to the figures. For simplicity and clarity of illustration, where considered appropriate, reference numerals may be repeated among the FIGs to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present embodiments provide an approach to reduce memory traffic and footprint during training with floating-point data such as BFloat16 or FP32; boosting energy efficiency and execution time performance. Approaches are provided to dynamically adjust the size and format of the floating-point containers used to store activations and weights during training. The different value distributions lead to different approaches for exponents and mantissas. Various embodiments are described herein and are given the monikers Gecko, Quantum Mantissa, BitChop, Quantum Exponent and Quantum Integer. Gecko exploits the favourable exponent distribution with a loss-less bias encoding approach to reduce the total exponent footprint by up to 58% in comparison to a 32 bit floating point baseline. Gecko is a loss-less compression approach for exponents by exploiting their favorable normal distribution. This approach can rely on delta encoding and a fine-grained approach to significantly reduce the exponent footprint of both weights and activation. To contend with the noisy mantissa distributions, two lossy approaches to eliminate as many as possible least significant bits, while not affecting accuracy, can be used. Quantum Mantissa, is a machine learning-first mantissa compression method that taps on training's gradient descent algorithm to also learn minimal mantissa bitlengths on a per-layer granularity, and obtain up to 92% reduction in total mantissa footprint. Quantum Mantissa is a machine learning technique to find required mantissa bitlength and involves a low-overhead modification of gradient descent to “learn” fine-grained (per tensor/layer) mantissa requirements during training. Alternatively, BitChop observes changes in the loss function during training to adjust mantissa bit-length network-wide yielding a reduction of 81% in footprint. BitChop is a heuristic based technique that finds the activation mantissas and tracks the current loss function to decide whether to add, remove, or keep the same the activation mantissa bitlength at network-level granularity. Quantum Exponent is a lossy machine learning approach for reducing the exponent bitlength. Schrödinger's FP can be used to implement hardware encoders/decoders that, guided by Gecko/Quantum Mantissa/Quantum Exponent or Gecko/BitChop/Quantum Exponent, transparently encode/decode values when transferring to/from off-chip memory boosting energy efficiency and reducing execution time. Furthermore, Quantum Integer is a machine learning approach that can learn lean fixed-point datatypes for training; which is particularly useful when it is known upfront that fixed-point arithmetic is sufficient for training.

Regardless of whether training is done using a single node or is distributed across several, such as in federated and distributed learning, single node performance and energy efficiency remains critically important. While training is both computationally and data demanding, it is memory transfers that dominate overall execution time and energy. Energy and time are dominated by data transfers for stashing (saving and later recovering) activation and weight tensors. Some approaches recompute activation tensors rather than stashing them, shifting the energy costs to compute rather than memory. Data blocking the form of micro-batching generally improves memory hierarchy utilization.

Other approaches revisit the datatype used during training. Training can use single precision floating-point data and arithmetic; however, more compact datatypes, such as half precision floating-point FP16, BFloat16, dynamic floating-point, and flexpoint, can be used to reduce overall traffic and improving energy efficiency for computations and memory. Rather than using a single datatype throughout, which has to provide the precision needed by all data and computations, some approaches explored using a combination of datatypes where more compact datatype are used for some, if not most, data and computations. Other approaches use low bitlength arithmetic.

In some cases, lossless and lossy compression approaches can be used because they use fewer bits to represent stashed tensor content; thus reducing overall traffic and footprints while improving energy efficiency and overall execution time. By boosting the effective capacity of each node's memory compression techniques, it can also reduce inter-node traffic during distributed training. These approaches target specific value patterns, such as zeros, or take advantage of the underlying mathematical properties of training to use efficient representations of certain tensors (such as the outputs of rectified linear activation function (ReLU) or pool layers). Some models can be trained using tighter floating-point representations where the mantissa and exponent are using fewer bits compared to Bfloat16 or FP32. Such approaches generally do not offer a method for determining which representation to use in advance. The user has to try to train the network to determine whether it can still converge. Furthermore, such approaches generally do not adjust the representation; which remains the same throughout training.

In some embodiments of the present disclosure, a family of lossy compression approaches can be used (informally referred to as ‘Schrödingers FP’), which can be used for training acceleration. Schrödinger's FP dynamically and continuously adjusts the mantissa bitlength (how many factional bits) and the container (how many bits overall) for floating-point values for stashed tensors; and does so transparently as much as possible (i.e., without anyone looking). The present embodiments can advantageously work with other training approaches, where the embodiments can be used to encode values as they are being stashed to off-chip memory and decode them to their original format (for example, FP32 and BFloat16) for reading back. As a result, the present embodiments can be used with many different types of training hardware without requiring changes to the existing on-chip memory hierarchy and compute units.

Fundamentally, compression relies on non-uniformity in the data value distribution statically and temporally. It is instructive to compare and contrast the behavior of floating-point values during training with the fixed-point values commonly used during inference; as many techniques capitalize on the properties of the value stream during inference. During inference:
Zeros are very common especially in models using ReLU.
The distribution of weights and activations during inference tend to be heavily biased around a centroid (often zero), with very few values having a magnitude close to the extremes of the value range and many “medium magnitude” values being exceedingly rare. This results in many values having long bit prefixes of 0 or 1 making it profitable to adapt the container bitlength accordingly.
The weights are statically known and can be pre-encoded.
Activations tend to be used quickly after production and may not need to be stored to off-chip memory.
It is possible to trim some of the least significant bits which are “noisy” yet not useful further skewing the value distribution.

In contrast to inference, adapting the container and bitlength of floating-point values during training has to contend with at least the following challenges:
Be it weights or activations, the values are changing continuously.
The initial values are random.
Floating-point values comprise a sign, exponent, and a normalized mantissa where a skewed value distribution does not necessarily translate into a skewed distribution at the bit-level.
Training often does minute updates to larger values and any method has to accommodate those updates which cannot be discarded as noise.
Activation values have to be stashed over much longer periods of time (produced during the forward pass and consumed during the backward pass).

Since the values are continuously changing at runtime, dynamism is generally desirable. Promisingly, while the initial values are random, training relatively quickly modifies them, resulting in overall distributions that are non-uniform; thus giving compression an opportunity to be effective. However, a challenge remains as this non-uniformity is obstructed by the use of a normalized mantissa coupled with an exponent. Specifically, even though the values produced after a while resemble the non-uniform distributions seen during inference, the normalized mantissa lacks the 0 or 1 bit prefixes that are common in fixed-point. At the same time, a fixed-point representation lacks the range and potentially the bitlengths needed to support the wide range of updates that stochastic gradient decent performs. Finally, with carefully chosen dataflow most of the gradients can be produced and consumed on-chip.

The present embodiments advantageously overcome the above challenges using different approaches for the mantissa and exponent. The present embodiments can dynamically adjust mantissa bitlengths in order to store and read fewer bits per number in off-chip memory. Embodiments described herein provide two such mantissa bitlength adaptation approaches. The first, informally referred to as ‘Quantum Mantissa’, harnesses the training algorithm itself to learn, on-the-fly the mantissa bitlengths that are needed per tensor/layer and continuously adapts those bitlengths per batch. Quantum Mantissa introduces a single learning parameter per tensor/layer and a loss function that measures the effects of the current bitlength selection.

Learning these bitlength parameters incurs a negligible overhead compared to the savings from the resulting reduction in off-chip traffic. Example experiments with Quantum Mantissa show that: 1) it is capable to reduce the mantissa bitlengths considerably (for example, down from 4 to 1 bits depending on the layer and epoch with BFloat16), and 2) the reductions are achieved fairly soon in the training process and remain relatively stable until the end (e.g., after epoch 5). However, the bitlengths vary per layer/tensor and fluctuate throughout; capturing benefits that would not be possible with a static choice of bitlengths.

Another mantissa adjustment approach is also provided herein, informally referred to as ‘BitChop’, which is a history-based, hardware-driven approach that requires no additional loss function and parameters. BitChop generally interfaces with the otherwise unmodified training system only in that it needs to be notified of per batch updates to the existing loss. It observes the changes in the loss and uses that information to adjust the mantissa length as appropriate for the purpose heuristic. In an example, BitChop uses an exponential moving average of these changes to the loss in order to make adjustments to the mantissa bitlength for the whole network. As long as the network appears to be improving, BitChop will attempt to use a shorter mantissa, otherwise it will keep it the same length, or in some cases, even increase it. Example experiments illustrate that BitChop is effective, albeit achieving lower reductions in mantissa length compared to Quantum Mantissa. This is expected since: 1) Quantum Mantissa harnesses the existing training process to continuously learn what bitlengths to use, and 2) Quantum Mantissa adjusts bitlengths per layer whereas BitChop uses one bitlength for all layers.

For the exponents, it was determined that most of the exponents during training exhibit a heavily biased distribution. Accordingly, in various embodiments of the present disclosure, the system can use a value-based approach, where exponents are stored using only as many bits as necessary to represent their magnitude plus sign. Metadata can be used to encode the number of bits used. To reduce the overhead of this metadata, exponents can be encoded in groups. Alternatively, embodiments of the present disclosure can use Quantum Exponent to learn shorter exponent lengths for all values in a group where in the preferred embodiment the group is a whole tensor.

Provided herein are efficient hardware compressors/decompressors that operate on groups of otherwise unmodified floating-point values be it FP32 or BFloat16. The compressors can accept an external mantissa length signal and pack the group of values using the aforementioned compression for the mantissas and exponents. The decompressors expand such compressed blocks back to into the original floating-point format.

Example experiments were conducted by the present inventors using ResNet18 and MobileNet V3 trained on ImageNet. For clarity, detailed results with ResNet18 with BFloat16 are provided, concluding with overall performance and energy efficiency measurements for all models. The following experimental findings were found:
The compression techniques of the present embodiments find the necessary mantissa and exponent bitlengths to reduce memory footprint without noticeable loss of accuracy: with Quantum Mantissa, SFP_{QM}, reduces ResNet18 down to 14.7% and MobileNet V3 Small to 23.7% and with BitChop, SFP_{B}c, to 24.9% and 27.2%, respectively.
The compressor/decompressor contributions exploit the reduced footprint to obtain 2.34× and 2.12× performance improvement for SFP_{QM} and SFP_{BC}, respectively.

The present embodiments excel at squeezing out energy savings with on average, 5.17× and 3.77× better energy efficiency for SFP_{QM} and SFP_{BC}, respectively.
The present embodiments can work in conjunction with approaches that partition, distribute, and reschedule the training work; particularly, methods that reduce the container size or the datatype used during training.

It has been demonstrated that the bulk of the memory transfers during training is due to stashed activations. Compression methods can be used to target two classes of activations: those between a ReLU and a Pooling layer, and those between a ReLU and a Convolutional layer. For the first class, one bit is typically enough, whereas for the second, the sparsity caused by ReLU can be used to avoid storing the resulting zeros. Using a reduced length floating-point format can allow the network to converge but the bitlength needed varies across models. In other approaches, bitlengths can be determined post-mortem, that is only after performing a full training run. Such approach is useful when a network has to be routinely retrained. In contrast, the present embodiments can discover, on-the-fly, which representation to use and can do so continuously throughout the training process, adapting as needed. Moreover, for exponents, it can take advantage of skewed value distributions, adapting the number of bits used to their actual values instead of using a one-size-fits-all.

Mixed-precision approaches generally use a mix of fixed-point and floating-point operations and values. Such approaches generally still use pre-decided and fixed data formats during the training process. Furthermore, they generally require modifications to the training implementation to take advantage of this capability. In contrast, embodiments of the present disclosure generally do not modify the underlying training implementation, rather, merely adjusting the data type and containers continuously, and encoding exponents based on their content. It has been demonstrated that training some models can be performed with the bulk of computations over extremely narrow formats using 4b (forward) and 8b (backward); albeit at some reduction in accuracy (roughly 2% absolute for MobileNet V2/ImageNet). Given the present dynamic and content-based approach, the present embodiments can be used in combination with such training methods to boost overall benefits.

Advantageously, the present embodiments can use a dynamic approach that takes advantage of value content for exponents and that does not modify the training implementation. Further advantageously, the present embodiments can make training more efficient. A task of a neural network can be almost anything, from natural language processing, recommendation systems, to computer vision. While many tasks are best solved with feed-forward networks, some perform better with feed-back connections. However, feed-back connections can be unraveled in time to produce feed-forward networks. Consequently, for illustrative purposes, the present disclosure will focus on feed-forward networks; however, other suitable network types can be used.

The goal of training a network is to determine the parameters that will best solve the given task. Without loss of generality, the present disclosure will focus on image classification networks for the purposes of explanation.

Training explicitly targets improving the value of a Loss Function. This is a function that acts as a proxy for the accuracy at solving the desired task. The requirements of this function is that it is differentiable and that the value of the function reduces as the output network approaches the desired value and the certainty of that output increases. In this case, the smaller the loss function, the more desirable the network performance. If these conditions are satisfied, it is fairly simple to devise updates for all parameters. The partial derivative of the loss function in respect of each parameter indicates how a change of the parameter will affect the loss function. Since the goal is the minimize the loss function, each parameter is bumped in the opposite direction of the partial derivative:

$${ω}_{i}^{l} = {ω}_{i}^{l} - L R \times \frac{δ L}{δ {ω}_{i}^{l}} \qquad ( 1 )$$

where wᵢ^{l} represents the i-th weight of layer l, LR represents the learning rate and L represents the Loss function.

This approach is repeated for every parameter, for many inputs, to slowly reach the weights at which the loss function is minimal, and as a result the accuracy is maximized. Crucially, if some property is to be optimized, say weight values, number of operations, or memory footprint, this can be included in the Loss function and the same procedure can be used. In order to use this procedure to update the weight, every operation used in the network must be differentiable.

In the forward pass, the training example is inputted and the Loss Function is calculated by sequentially calculating all the activations in order. This involves simply computing the output of each layer l sequentially:

$${a}_{i}^{l + 1} = {F}^{l} ( {\sum }_{i} {ω}_{i , j}^{l} \times {a}_{i , j}^{l} ) \qquad ( 2 )$$

where aᵢ^{l+1} represents the i-th activation of layer l+1, w_{i,j}^{l} and a_{i,j}^{l} represent the weights and activations of layer l that are directly connected to aᵢ^{l+1} and F^{l} is a non-linear differentiable activation function of the l-th layer. The input activation of each layer, for every input, needs to be saved to in order to compute the backward pass.

The backward pass utilizes the chain rule to progressively find the partial derivative of the loss function with respect to the weights. In this case, the reuse of calculated values is maximized. The process involves two steps for every layer, applied in reverse order, from the last to the first:
Weight Update: First, the input is computed the updated weights of the current layer:

$${ω}_{i}^{l} = {ω}_{i}^{l} - LR \times {\sum }_{j} {a}_{i , j}^{l} \times \frac{δ L}{δ {a}_{j}^{l + 1}} \qquad ( 3 )$$

where LR is the learning rate, a_{i,j}^{l} are the activations connected to the weight and

$$\frac{δ L}{δ {a}_{j}^{l + 1}}$$

is the activation gradient from the l+1-th layer.
Propagate Gradient Backward: Second, the gradient is propagated backward into the previous layer by computing:

$$\frac{δ L}{δ {a}_{i}^{l}} = {\sum }_{j} {w}_{i , j}^{l} \times \frac{δ L}{δ {a}_{j}^{l + 1}} \times \frac{δ {F}^{l}}{δ {a}_{j}^{l}} ( {a}_{j}^{l} ) \qquad ( 4 )$$

where w_{i,j}^{l} and

$$\frac{δ L}{δ {a}_{j}^{l + 1}}$$

are all weight/output gradient pairs connected to the input gradient and F^{l} is the activation function of layer l. Only at this point can the activations of this layer be discarded. These steps can be repeated all the way to the input layer. Once this is done, one weight tensor update is completed. This can be repeated for every input batch.

While training is expensive both compute-wise and memory-wise, off-chip memory accesses dominate the energy and time costs since computing the weight updates necessitates retrieving the activations from the forward pass. This is generally a massive amount of data. For ResNet18 on ImageNet, with a batch size of 256 images, the volume of activations is on the order of gigabytes; far exceeding practical on-chip capacities.

In many cases, the core of training is the Gradient Descent procedure: slowly, step-by-step moving against the gradient to find the parameters that produce the minimum loss. This approach is being continuously improved to find better minima quicker and cheaper. However, the basics and hardware implications remain the same; lots of computation and even more memory.

The present embodiments reduce the energy and time cost of training by leveraging machine learning and hardware techniques to reduce memory footprint and traffic. This is achieved, at least, by selecting an elastic datatype and container coupled with light-weight, custom encoder/decoder hardware that exploits it to reduce off-chip traffic and footprint. Provided herein are:
Quantum Mantissa: A machine learning technique to find required mantissa bitlength. This technique involves a low-overhead modification of gradient descent to “learn” fine-grained (per tensor/layer) mantissa requirements during training.
BitChop: A heuristic based technique that finds the activation mantissas. This method tracks the current loss function and decides whether to add, remove, or keep the same activation mantissa bitlength at network-level granularity.
Gecko: A loss-less compression method for exponents by exploiting their favorable normal distribution. This method relies on delta encoding and a fine-grained approach to significantly reduce the exponent footprint of both weights and activation. Alternatively, Quantum Exponent can be used to adjust the exponent container during learning. It uses a low-overhead modification of gradient descent to “learn” fine-grained (per tensor/layer/or other desired granularity) exponent requirements during training.
Quantum Integer builds upon the Quantum Mantissa approach for fixed-point data datatypes that do not use exponents.
A hardware architecture to exploit the custom datatype and deliver energy and performance benefits for neural network training.

Reducing the energy and time cost of training can include defining an efficient datatype. In general, training requires a floating-point approach in order to maintain accuracy on most real-world tasks. Floating-point formats consist of three distinct segments: a mantissa, an exponent, and a sign bit. Mantissas and exponents are differently distributed, so they require different approaches. A significant challenge is compressing mantissas since they are uniformly distributed across the domain, whereas compression generally exploits non-uniformity. Two approaches to compress mantissas are provided, a machine learning approach and a hardware design inspired approach. Similarly, the sufficient bitlength of exponents can be learned. Exponents generally exhibit a skewed distribution and can be compressed with relatively simple hardware techniques on top of either full precision or reduced precision bitlength.

In a first approach, informally referred to as the Quantum Mantissa approach, involves procedures for both the forward and backward passes of training. A quantization scheme can be used for integer mantissa bitlengths in the forward pass and then expanded to the non-integer domain, which allows bitlengths to be learned using gradient descent. A parameterizable loss function is provided that enables Quantum Mantissa to penalize larger bitlengths. The example experiments illustrate the benefits of Quantum Mantissa on memory footprint during ImageNet training.

A substantial challenge for learning bitlengths is that they represent discrete values over which there is no obvious differentiation. To overcome this challenge, a quantization method is defined on non-integer bitlengths. An integer quantization of the mantissa M with n bits is performed by zeroing out all but the top n bits:

$$Q ( M , n ) = M ∧ ( {2}^{n} - 1 ) ≪ ( m - n ) \qquad ( 5 )$$

where Q(M, n) is the quantized mantissa with bitlength n, m is the maximum number of bits and represents bitwise AND. The zeroing out of the top n bits may be implemented by removing the top n bits from the mantissa.

Throughout training, the integer quantization is represented as Q(M, n). This quantization scheme generally does not allow the learning of bitlengths with gradient descent due to its discontinuous and non-differentiable nature. To expand, the definition to real-valued n=└n┘+{n}, the values used in inference during training can be selected as a random choice between the nearest two integers with probabilities {n} and 1−{n}:

$$Q ( M , n ) = \{ \begin{matrix}Q ( M , ⌊ n ⌋ ) , & with probability 1 - \{ n \} \\ Q ( M , ⌊ n ⌋ + 1 ) , & with probability \{ n \}\end{matrix} \qquad ( 6 )$$

where └n┘ and {n} are floor and fractional parts of n, respectively. The scheme can be applied to activations and weights separately. Since the minimum bitlength per value is 0, n can be clipped at 0. This presents a reasonable extension of the meaning of bitlength in continuous space and allows for the loss to be differentiable with respect to bitlength.

During the forward pass, the above formulae can be applied to both activations and weights. The quantized values can be saved and used in the backward pass. During the backward pass, a straight-through estimator can be used to prevent propagating zero gradients that result from the discontinuity's discreteness; however, the quantized mantissas for all calculations can be used. This efficient quantization during the forward pass reduces the footprint of the whole process.

On top of finding the optimal weights, the modified loss function penalizes mantissa bitlengths by adding a weighted average (with weights λᵢ not be confused with the model's weights) of the bits mᵢ required for mantissas of weights and activations. A total loss L is defined as:

$$L = {L}_{l} + γ \sum ( {λ}_{i} \times {n}_{i} ) \qquad ( 7 )$$

where Lₗ is the original loss function, γ is the regularization coefficient used for selecting how aggressive the quantization should be, λᵢ is the weight corresponding to the importance of the i^{th} group of values (one per tensor), and nᵢ is the bitlength of the activations or weights in that tensor.

This loss function can be used to target any quantifiable criteria by a suitable selection of the λᵢ parameters. Since the general goal is to minimize the total footprint of a training run, each layer's tensors can be weighted according to their footprint. Alternatively, just weight decay, or any other mechanism, can be used to minimize the mantissa bitlengths.

Quantum Mantissa generally adds minimal computational and memory overhead to the forward and backward passes. In the forward pass, random numbers can be created at a chosen granularity to determine the quantized values. Ideally this is performed per value; however, the example experiments show that per tensor/layer is sufficient and is a negligible cost.

To update the bitlength parameters in the backward pass, their gradients can be determined. These are a function of the weight values and gradients, which will be calculated as part of regular backward pass. As a result, the extra calculations for each bitlength are on the order of O(n), where n is the number of values quantized to that bitlength. This overhead is generally negligible in comparison to the total number of computations. In the case of the example experiments, the overhead is less than 2% and 0.5% for MobileNet V3 and ResNet18, respectively.

With respect to memory requirements, the only extra parameters that need to be saved are the bitlengths, two floats per layer (bitlength for weights and activations). This is generally negligible in comparison with the total footprint. All other values are consumed as they are produced without need for off-chip stashing.

The above approach produces non-integer bitlengths and requires stochastic inference; given a fractional bitlength, one of the surrounding integer bitlengths can be selected at random per tensor. It is preferred that the network not to have this requirement when deployed. For this reason, in some cases, the bitlengths can be round up and fixed for some training time to fine-tune the network to this state. While the example experiments show that bitlengths converge quickly and final bitlengths can be determined within a couple of epochs avoiding the small overhead for most of training, in some cases, this action can be delayed so that bitlengths have the ability to increase if needed during training. The example experiments show that this is unnecessary for the models studied; however, the overhead is so small that it can be left on as a safety mechanism. In some cases, the bitlengths for the last 10 epochs can be round up to let the network regain any accuracy that might have been lost due to Quantum Mantissa. Quantum Mantissa still reduces traffic during these epochs.

Measurements for per-layer weights and activations can be quantized separately using a loss function weighted to minimize total memory footprint. In the example experiments, ResNet18 was trained on the ImageNet dataset over 90 epochs, with 0.1 weight decay, setting the regularizer strength to 0.1, 0.01 and 0.001 respectively at epochs 0, 30, and 60.

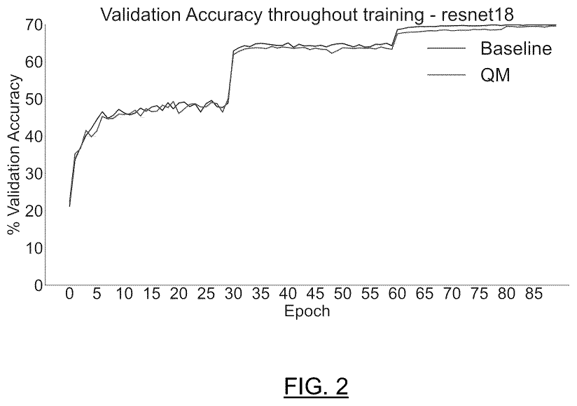

A particular advantage of Quantum Mantissa is the ability to tap onto the learning algorithm to minimize the memory footprint, whilst not introducing accuracy loss. FIG. 2 shows that throughout training, Quantum Mantissa introduces minimal changes in validation accuracy. In the end, the network converges to a solution within 0.4% of the FP32 baseline.

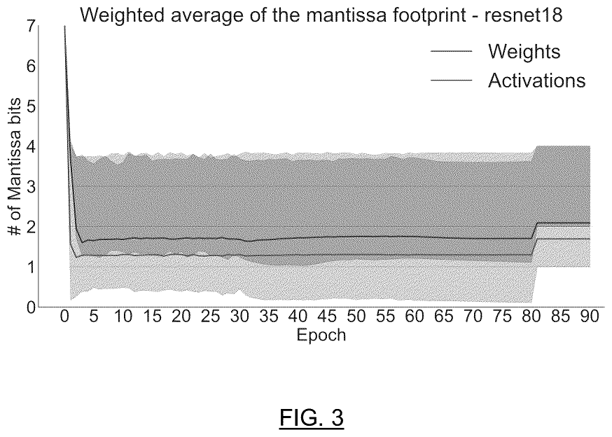

FIG. 3 shows how Quantum Mantissa quickly (within a couple of epochs) reduces the required mantissas for activations and weights down to 1 to 2 bits on average. Throughout training, the total cumulative memory footprint is reduced to 7.8% and 25.5% of the FP32 and BFloat16 mantissa footprint, respectively. FIG. 3 further shows that there is a large spread across different layers, indicating that a granular, per-layer, approach is the right choice to maximize benefits. Quantum Mantissa generally targets the activation bitlengths more aggressively than the weights as the activations are responsible for the majority of the memory footprint. This is contrary to the case when the bitlengths are not weighted according to their importance and the weights end up being smaller than the activations.

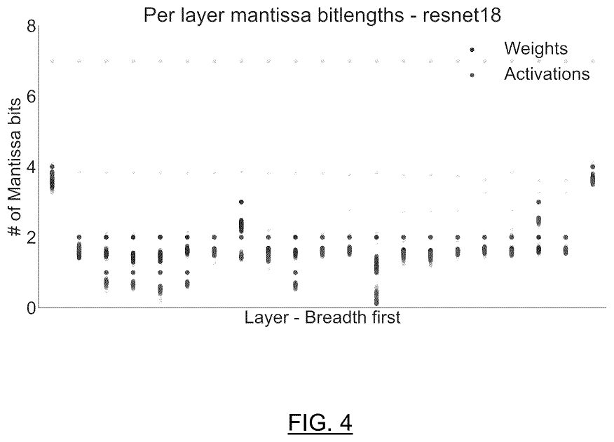

The spread of mantissa bitlengths across the network and time is shown in FIG. 4. While most layers quickly settle at 1 or 2 bits, there are a couple of exceptions that require more, at times up to 4 bits. Because of this spread, a network-scale datatype would have to use the largest datatype and leave a lot of the potential untapped. For ResNet18, the maximum bitlength is over 2× larger.

While the present disclosure is generally directed to learning optimal floating-point datatypes, it is understood that the present embodiments can be adapted to learn optimal inference datatypes for efficient training. For example, Quantum Integer builds upon the Quantum Mantissa approach but switches out Equation (5) for one that represents fixed-point data datatypes that do not use exponents. Quantum Integer not only reduces traffic and footprint in memory during training similarly to Quantum Mantissa, but also adds the constraint that the weight and values used eventually during inference would be integers. Integers are substantially less expensive to use during inference reducing memory, computation and energy needs.

Quantum Integer approach involves procedures for both the forward and backward passes of training. A quantization scheme can be used for integer mantissa bitlengths in the forward pass and then expanded to the non-integer domain, which allows bitlengths to be learned using gradient descent. A parameterizable loss function is provided that enables Quantum Integer to penalize larger bitlengths.

The substantial challenge for learning bitlengths is that they represent discrete values over which there is no obvious differentiation. To overcome this challenge, a quantization method is defined on non-integer bitlengths. An integer quantization of the value V with n bits is performed by defining uniform quantization with n bits:

$$Q ( V , n ) = {V}_{min} + Int ( V , n ) \times Scale ( n )$$

$$Scale ( n ) = ( {V}_{max} - {V}_{min} ) / ( {2}^{n} - 1 )$$

$$Int ( V , n ) = Round ( V - {V}_{min} ) / Scale ( n )$$

where Q(V, n) is the quantized value with bitlength n and Vₘₐₓ and Vₘᵢₙ in are the maximum and minimum values in the tensor. Vₘₐₓ and Vₘᵢₙ can be determined in advance, determined in real time based on the largest and smallest element in each tensor, or learned as boundaries with a parametrized activation function.

Throughout training, the integer quantization is represented as Q(V, n). This quantization scheme generally does not allow the learning of bitlengths with gradient descent due to its discontinuous and non-differentiable nature. To expand, the definition to real-valued n=└n┘+{n}, the values used in inference during training can be selected as a random choice between the nearest two integers with probabilities {n} and 1−{n}:

$$Q ( V , n ) = \{ \begin{matrix}Q ( V , ⌊ n ⌋ ) , with probability 1 - \{ n \} \\ Q ( V , ⌊ n ⌋ + 1 ) , with probability \{ n \}\end{matrix} \qquad ( 6 )$$

where └n┘ and {n} are floor and fractional parts of n, respectively. The scheme can be applied to activations and weights separately. Since the minimum bitlength per value is 1, n can be clipped at 1. This presents a reasonable extension of the meaning of bitlength in continuous space and allows for the loss to be differentiable with respect to bitlength.

During the forward pass, the above formulae can be applied to both activations and weights. For activations the quantized values can be saved and used in the backward pass. During the backward pass, a straight-through estimator can be used to prevent propagating zero gradients that result from the discontinuity's discreteness; however, the quantized values for all calculations can be used. This efficient quantization during the forward pass reduces the footprint of the whole process. The weights can be stored in floating point to allow updates during the backward pass. However, during the calculations of the forward pass and the backward pass, the floating-point weights can be converted to integers, thus reducing memory traffic as described for Quantum Mantissa.

On top of finding the optimal weights, the modified loss function penalizes mantissa bitlengths by adding a weighted average (with weights λᵢ not be confused with the model's weights) of the bits nᵢ required for bitlengths of weights and activations. A total loss L is defined as:

$$L = {L}_{l} + γ \sum ( {λ}_{i} \times {n}_{i} ) \qquad ( 7 )$$

where Lₗ is the original loss function, γ is the regularization coefficient used for selecting how aggressive the quantization should be, λᵢ is the weight corresponding to the importance of the i^{th} group of values (one per tensor), and nᵢ is the bitlength of the activations or weights in that tensor.

This loss function can be used to target any quantifiable criteria by a suitable selection of the A; parameters. Since the general goal is to minimize the total footprint of a training run, each layer's tensors can be weighted according to their footprint. Alternatively, just weight decay, or any other mechanism, can be used to minimize the mantissa bitlengths.

Quantum Integer generally adds minimal computational and memory overhead that is comparable to the one of Quantum Mantissa.

The final selection of bitlengths of Quantum Integer is identical to the one of Quantum Mantissa. The above approach produces non-integer bitlengths and requires stochastic inference; given a fractional bitlength, one of the surrounding integer bitlengths can be selected at random per tensor. It is preferred that the network not to have this requirement when deployed. For this reason, in some cases, the bitlengths can be round up and fixed for some training time to fine-tune the network to this state.

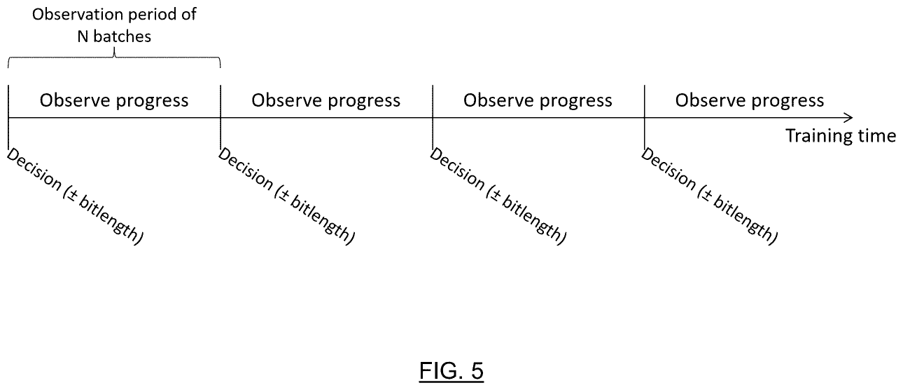

While Quantum Mantissa leverages training itself to greatly reduce mantissa lengths, in another embodiment, the BitChop approach is provided that does not require introducing an additional loss function and parameters. BitChop is a run-time, heuristic method to reduce the number of mantissa bits for the forward and backward passes. At a high-level, BitChop monitors how training progresses, adjusting the mantissa length accordingly. As long as the training seems to be improving the network, BitChop will attempt to use a shorter mantissa, otherwise it will try to increase its bitlength. FIG. 5 illustrates BitChop's “observe and adjust” approach. BitChop conceptually splits the training process into periods, where a period is defined as processing N batches. BitChop adjusts the mantissa at the end of each period using information about network progress.

BitChop is particularly advantageous in scenarios where past observation periods are good indicators of forthcoming behavior. Macroscopically, network accuracy improves over time during training, which appear to be a good fit. Microscopically, however, training is a fairly noisy process, a reality that BitChop has to contend with. Fortunately, training is a relatively long process based on “trial-and-error”, which may be forgiving for momentary lapses in judgement.

In an example, there are three major design decisions that impact BitChop: 1) what information to use as a proxy for network progress, 2) how long the period should be, and 3) at what granularity to adjust mantissa lengths. The approach should strike a balance between capturing as much as possible of the opportunity to reduce bitlength, while avoiding over-clipping as this can hurt learning progress and ultimately the final accuracy that will be achieved.

In an example, the present inventors arrived at the following choices: 1) using an exponential moving average of the loss as a proxy for network progress, and 2) using a short period where N=1, that is a single batch. Moreover, rather than attempting to adjust mantissas at the tensor/layer level, BitChop can use the same mantissa for the whole model.

In an example, to monitor network progress, BitChop can use the loss which is calculated per batch as part of the regular training process. While the loss improves over time, when observed over short periods of time, it exhibits non-monotonic behavior; which is sometimes erratic. To compensate for this volatility, BitChop uses an exponential moving average Mavg, which it updates at the end of each period:

$$Mavg = Mavg + α * ( {L}_{i} - Mavg ) \qquad ( 8 )$$

where Lᵢ is the loss during the last period and α is an exponential decay factor which can be adjusted to assign more or less significance to older loss values. This smooths the loss over time while giving importance to the most recent periods.

At the end of each period i, BitChop decides what the mantissa bitlength, bitlengthᵢ₊₁, should be for the next period i+1, as follows:

$${bitlength}_{i + 1} = \{ \begin{matrix}{bitlength}_{i} - 1 , & when Mavg > {L}_{i} \\ {bitlength}_{i} , & when Mavg = {L}_{i} \\ {bitlength}_{i} + 1 , & when Mavg < {L}_{i}\end{matrix} \qquad ( 9 )$$

where Lᵢ and bitlengthᵢ are respectively the loss and the mantissa length of period i. In an example, BitChop can be implemented as a simple hardware controller which is notified of the loss via a user-level register in memory. The only modification to the training code is for updating this register once per period.

Evaluation of bitlengths and accuracy involves measuring the effectiveness of BitChop by reporting its effect on memory footprint and accuracy during full training sessions of ResNet18, as described herein for Quantum Mantissa. In some cases, BitChop can adjust the mantissa for activations and weights.

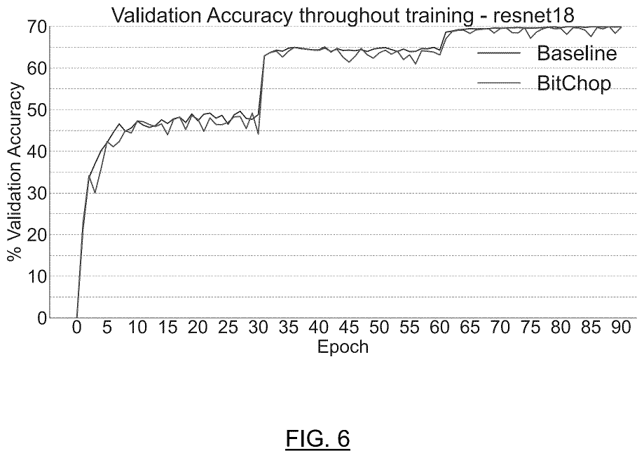

FIG. 6 shows that with BitChop, the network achieves the same validation accuracy as with the baseline training. For clarity, FIG. 6 shows results for BFloat16 only (results with FP32 were similar and accuracy was unaffected). Throughout the training process, validation accuracy under BitChop exhibits more pronounced swings compared to the baseline and to Quantum Mantissa. However, in absolute terms, these swings are small as the validation accuracy under BitChop closely follows that observed with baseline training.

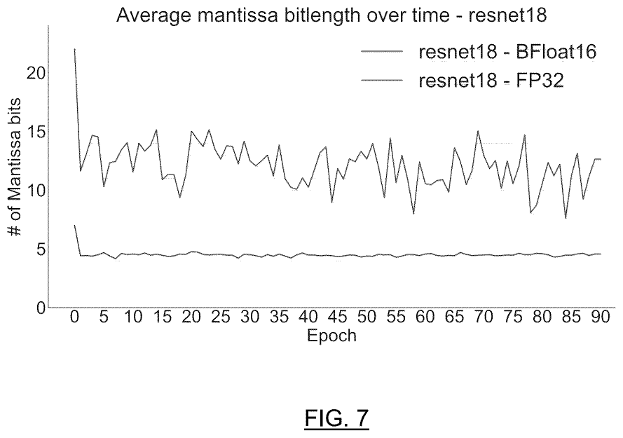

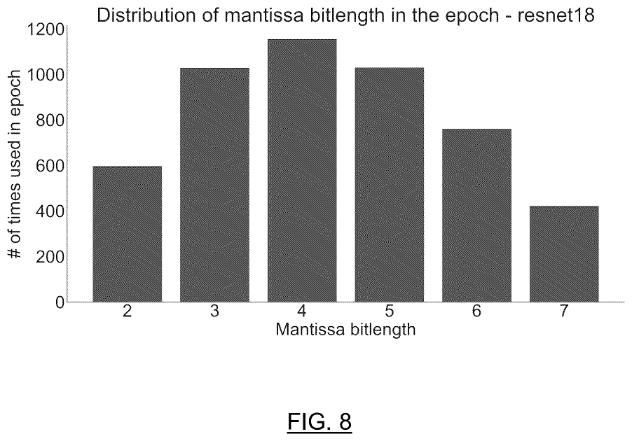

FIG. 7 shows that BitChop reduces mantissa bitlengths to 4 to 5 bits on average when used over BFloat16 and to 5-6 bits on average when used over FP32. However, the mantissa bitlength may vary per batch depending on the loss. This is illustrated in FIG. 8, through a histogram of the bitlengths used throughout a sample epoch (epoch 45) for the BFloat16 run. This shows that while BitChop is consistently reducing the mantissa bitlength to 3 to 5 bits, the training process sometimes requires the entire range of Bfloat16, whereas other times it only requires 2 bits. All across the training process, BitChop reduces the total mantissa footprint of the BFloat16 baseline to 64.3. Over FP32, BitChop reduces mantissa footprint to 52.3%.

While BitChop's network-level granularity might miss potential bitlength reductions, it does not require extra trainable parameters or any modification to the training process. Nor does it introduce any explicit overhead, making it a ‘plug-in’ adjustment to the training process.

In another approach, informally referred to as the Quantum Exponent, operations are performed for both the forward and backward passes of training. Quantum Exponent is a stochastic training approach to find optimal bitlengths for the floating-point exponents. Quantum Exponent involves operations for both the forward and backward passes of training. Limiting the exponent range affects the real range of numbers represented by the floating-point number. In this way, the system can parametrize the allowable range limits and use a straight-through estimator to define a gradient. A quantization scheme can then be used for integer exponent bitlengths in the forward pass, where the exponent bit length is directly connected to the limit of the real range of floating-point values; which can be expanded to the non-integer domain. Quantum Exponent allows bitlengths to be learned using gradient descent; for example, using a modified loss function, which enables Quantum Exponent to penalize larger bitlengths.

Reducing the exponent length has the effect of reducing the range of the real value. In particular, reducing the exponent to [Eₘᵢₙ, Eₘₐₓ] reduces the range to:

$$V ( E ) ∈ [ - {V}_{max} , - {V}_{min} ] ⋃ [ {V}_{min} , {V}_{max} ]$$

where Vₘₐₓ and Vₘᵢₙ are the absolute values of the limits of V with the given exponent range:

$${V}_{max} = ( 1 + {M}_{max} ) \times {2}^{{E}_{max}}$$

$${V}_{min} = {2}^{{E}_{min}}$$

where Mₘₐₓ is the maximum possible mantissa value.

To learn the exponents, the parametrization range can be defined with the following function (where Vₘₐₓ and Vₘᵢₙ are boundaries from equations above):

$$F ( V , {V}_{max} , {V}_{min} ) = \{ \begin{matrix}- {V}_{max} , V < - {V}_{max} \\ V , - {V}_{max} \leq V < {V}_{min} \\ 0 , - {V}_{min} < V < {V}_{min} \\ V , {V}_{min} < V \leq {V}_{max} \\ {V}_{max} , V > {V}_{max}\end{matrix}$$

The partial derivatives of this function can be defined with respect to Vₘₐₓ and Vₘᵢₙ:

$$\frac{\partial F}{\partial {V}_{max}} = \{ \begin{matrix}- 1 , V < - {V}_{max} \\ 0 , {V}_{max} \leq V \leq {V}_{max} \\ 1 , V > {V}_{max}\end{matrix}$$

$$\frac{\partial F}{\partial {V}_{min}} = \{ \begin{matrix}0 , V \leq - {V}_{min} \\ 1 , - {V}_{min} < V < 0 \\ - 1 , 0 < V < {V}_{min} \\ 0 , {V}_{min} \leq V\end{matrix}$$

In order to determine the gradient for Vₘₐₓ and Vₘᵢₙ, the gradients in the layer are summed.

Learning exponent bitlengths can be particularly challenging because they represent discrete values over which there is no obvious differentiation. To overcome this challenge, a mapping for integer exponent bitlength can be used, which can be expanded to a continuous domain using, for example, one of the three approaches described herein.

An integer quantization of the exponent E with n bits can be determined by defining a range and directly mapping it to Vₘₐₓ and Vₘᵢₙ:

$${V}_{max} = ( 1 + {M}_{max} ) \times {2}^{{E}_{max}}$$

$${V}_{min} = {2}^{{E}_{max}}$$

where Mₘₐₓ is the largest possible mantissa, Eₘₐₓ is the largest possible exponent, and Eₘᵢₙ is the smallest possible exponent. In other cases, a weight decay approach can be used.

Eₘₐₓ can be represented as:

$${E}_{max} = {E}_{min} + {2}^{n} - 1$$

where n is the learnable exponent bitlength. Similarly, Eₘᵢₙ is the exponent bias of the exponent that can be learned as well.

Alternatively, the above can be reformulated with a learnable median Eₘ:

$${E}_{max} = {E}_{m} + {2}^{n - 1} - 1$$

$${E}_{min} = {E}_{m} - {2}^{n - 1}$$

The following are three exemplary approaches to expand the exponent integer bitlength to the continuous domain.

A first approach is to directly map the non-integer exponent length n to Vₘₐₓ and Vₘᵢₙ by using the equations above. In this case, the exponent will be represented by └n┘+1 and the mantissa will represent the value such a value that Vₘₐₓ and Vₘᵢₙ are equal to equations above. However, in some cases, all values represented by the threshold value will have a mantissa that is rapidly changing.

The second approach is to stochastically choose the exponent value. The non-integer exponent length n can be mapped to Vₘₐₓ and Vₘᵢₙ, ensuring that Vₘₐₓ and Vₘᵢₙ are integers by using stochastic choice. In this case, the exponent will be represented by └n┘+1, but the mantissa will always remain Mₘₐₓ. The exponents can then be calculated as:

$${E}_{min} = \{ \begin{matrix}⌊ {E}_{min} ⌋ , with probability 1 - \{ {E}_{min} \} \\ ⌊ {E}_{min} ⌋ + 1 , with probability \{ {E}_{min} \}\end{matrix}$$

The benefit of the second approach is that the mantissa of the threshold value remains constant; however, the exponent is not the maximum of its range.

The third approach is to stochastically map the non-integer exponent length n to an integer. In this case, the exponent will be represented by └n┘+1, but the mantissa will always remain Mₘₐₓ. The exponents can then be calculated as:

$${E}_{min} = \{ \begin{matrix}⌊ {E}_{min} ⌋ , with probability 1 - \{ {E}_{min} \} \\ ⌊ {E}_{min} ⌋ + 1 , with probability \{ {E}_{min} \}\end{matrix}$$

$${E}_{max} = \{ \begin{matrix}{E}_{min} + {2}^{⌊ n ⌋} - 1 , with probability 1 - \{ n \} \\ {E}_{min} + {2}^{⌊ n ⌋} - 1 + 1 , with probability \{ n \}\end{matrix}$$

The benefit of the third approach is that both the mantissa and the exponent of the threshold value are the maximum of the allowable range.

Similar to Quantum Mantissa, Quantum Exponent can be applied to activations and weights separately. Since the minimum bitlength per value is 0, n is clipped at 0. This presents a reasonable extension of the meaning of bitlength in continuous space and allows for the loss to be differentiable with respect to bitlength.

During the forward pass, the above formulae can be applied to both activations and weights. The quantized values can be saved and used in the backward pass. During the backward pass, a straight-through estimator can be used to prevent propagating zero gradients that result from the discontinuity's discreteness; however, the quantized exponents for all calculations can be used. This efficient quantization during the forward pass reduces the footprint of the whole process.

In addition to finding the optimal weights, the modified Loss Function can penalize exponent bitlengths by adding a weighted average of the exponent bits. This can be performed in the same way as the modified loss for Quantum Mantissa. Alternatively, weight decay can be used to minimize the exponent bitlengths.

The overhead introduced by Quantum Exponent is generally similar to the one introduced by Quantum Mantissa. Quantum Exponent can also generally use the same approach to select the final exponent bitlengths as used in Quantum Mantissa.

All the aforementioned methods, eventually learn and produce a per weight and activation tensor, or a network-wide, data container profile. Should the network need to be retrained, or fine-tuned (which amounts to running a few additional training epochs over the trained model) it may be advantageous to start with the already learned datatype profile rather than start with the default, more expensive datatype, and learn the profile anew. Preferentially, it is not typically necessary to enable further adjustments to the datatypes during this second training or fine-tuning process.

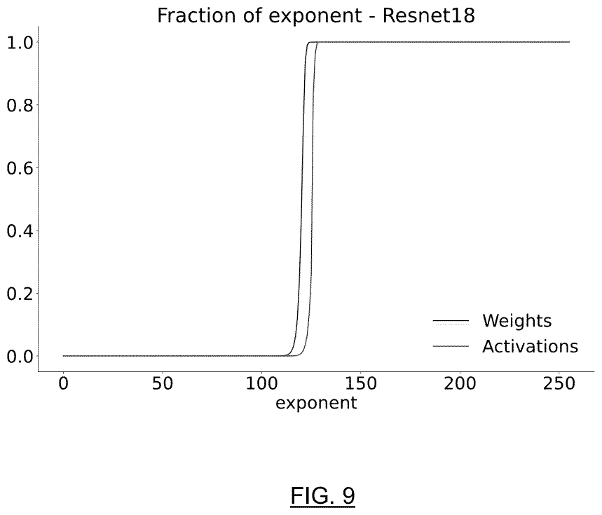

The exponents of BFloat16 and FP32 are 8b biased fixed-point numbers. Except for a few early batches, during the example experiments, it was found that during training the exponent values exhibit a heavily biased distribution centered around 127; which represents 0. This is illustrated in FIG. 9, which reports the exponent distribution throughout training of Resnet18 after epoch 10 (the figure omits gradients which are even more biased as those can be kept on-chip). Taking advantage of the relatively small magnitude of most exponents, a variable length lossless exponent encoding was adopted. The encoding used only as many bits as necessary to represent the specific exponent magnitude rather than using 8b irrespective of value content. Since variable-sized exponents are used, a metadata field specifies the number of bits used. Having a dedicated bitlength per value would negate any benefits, or worse become an overhead. To amortize the cost of this metadata, several exponents share a common bitlength, which is long enough to accommodate the highest magnitude within the group. It is further observed that, especially for weights, the values often exhibit spatial correlation, that is values that are close-by tend to have similar magnitude. Encoding differences in value skews the distribution closer to zero benefiting the encoding scheme.

An encoding scheme, informally referred to as ‘Gecko’, in accordance with the present embodiments, can be implemented. A particular example is now provided without loss of generality. Given a tensor, Gecko first groups the values in groups of 64 (padding as needed), which it treats conceptually as an 8×8 matrix. Every column of 8 exponents is a group which shares a common base exponent. The base exponent per column is the exponent that appears in the first row of incoming data. The base exponent is stored in 8 bits (8b) (or fewer if using Gecko on top of Quantum Exponent as explained below). The remaining 7 exponents are stored as deltas from the base exponent. The deltas are stored as [magnitude, sign] format using a bitlength to accommodate the highest magnitude among those per row. A leading 1 detector determines how many bits are needed. The bitlength is stored using 3b and the remaining exponents are stored using the bitlength chosen. Alternatively, a fixed bias can be used to encode the exponents. In this case, a predetermined bias b is used to encode the exponents in memory were an exponent E is stored as E b and with as many bits as necessary to store the magnitude of this difference. The bias can be determined up-front or can be fixed in the design. In the example experiments, a bias of 127 was found to be best for the models studied in the experiments; but any suitable value can be used. In some cases, exponents can be encoded in smaller groups; and it was found that a group of 8 works very well in the example experiments. Alternatively, the exponents can be stored in their original form trimmed as instructed by Quantum Exponent. In this case, Gecko accepts as input the number of bits e to use per exponent. For example, if the original representation was using 8 bits per exponent and e of 5 is given Gecko will remove the 2 least significant bits from the exponent.

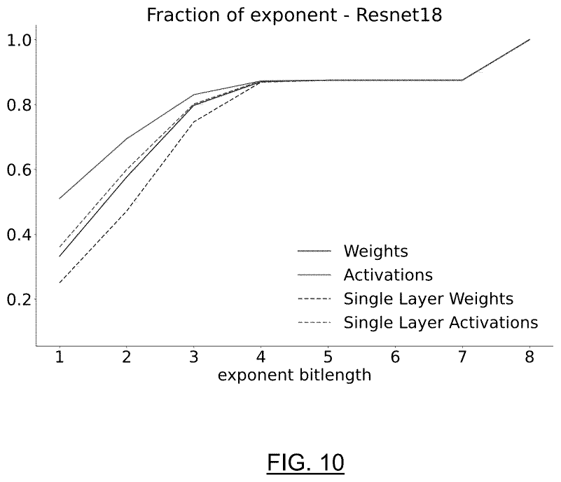

For bitlength, the number of bits needed to encode the exponents using Gecko can be determined for the duration of training, as described herein. As a representative measurement, FIG. 10 reports the cumulative distributions of exponent bitlength for one batch across 1) all layers, and 2) for a single layer, and separately for weights and activations. After delta encoding, almost 90% of the exponents become lower than 16. Further, 20% of the weight exponents and 40% of the activation exponents end up being represented using only 1 bit. Across the whole training process, the overall compression ratio for the weight exponents is 0.56 and 0.52 for the activation exponents. The ratio is calculated as (M+C)/O where M the bits used by the per group bitlength fields, C the bits used to encode the exponent magnitudes after compression, and O the bits used to encode exponents in the original format.

One of the simplest and most common activation functions used for CNNs is the Linear Rectifier (ReLU), which zeroes out all negative values. As a result, ReLU outputs can be stored without the sign bit.

The present embodiments can use hardware encoder/decoder units that efficiently exploit the potential created by the quantization schemes described herein. Without the loss of generality, described herein are compressors/decompressors that process groups of 64 FP32 values.

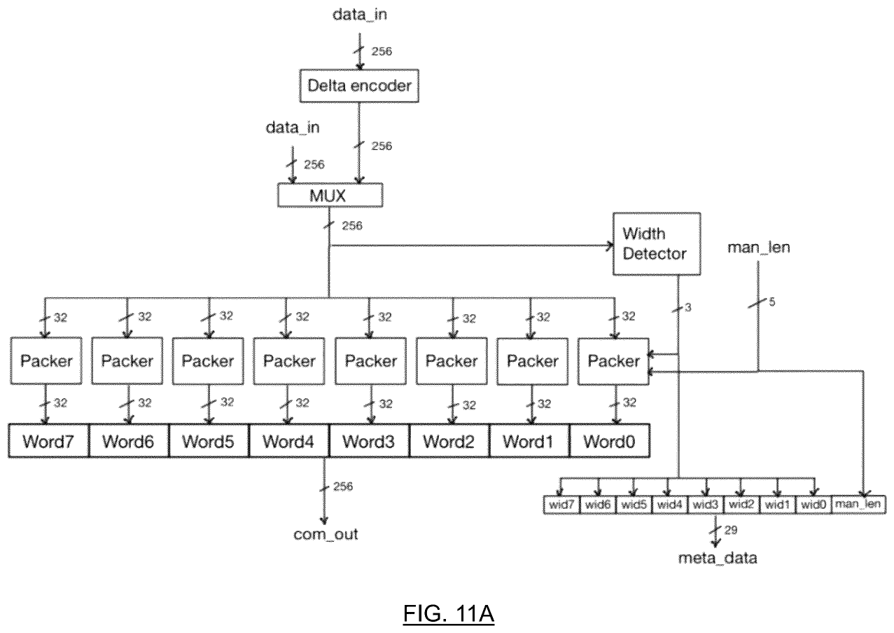

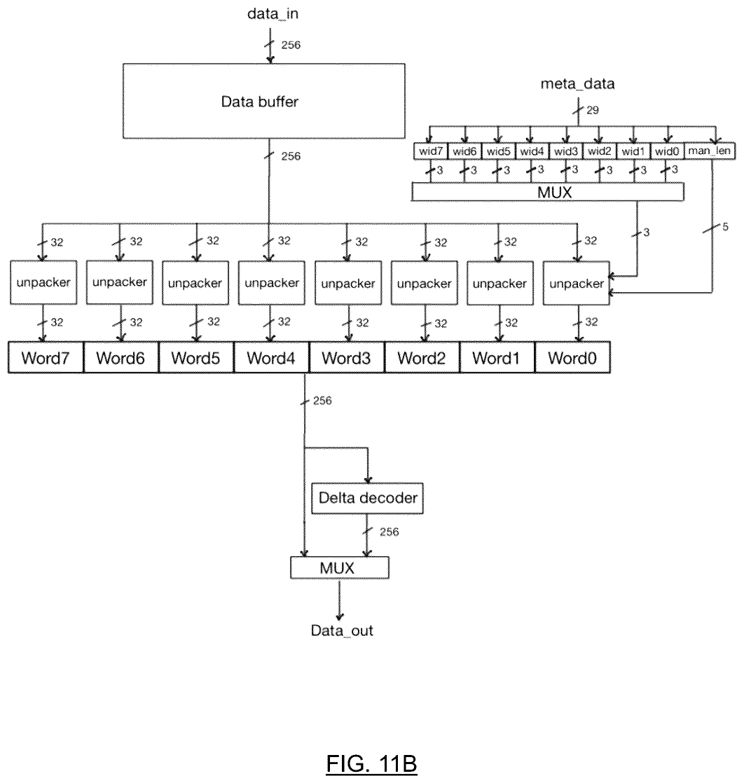

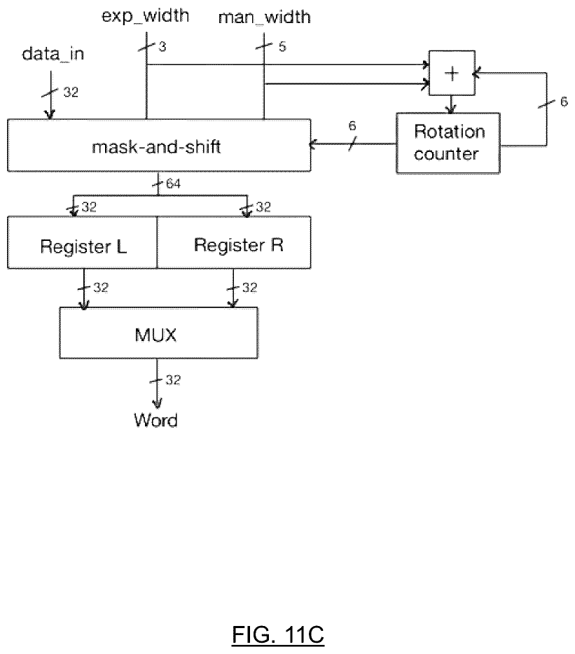

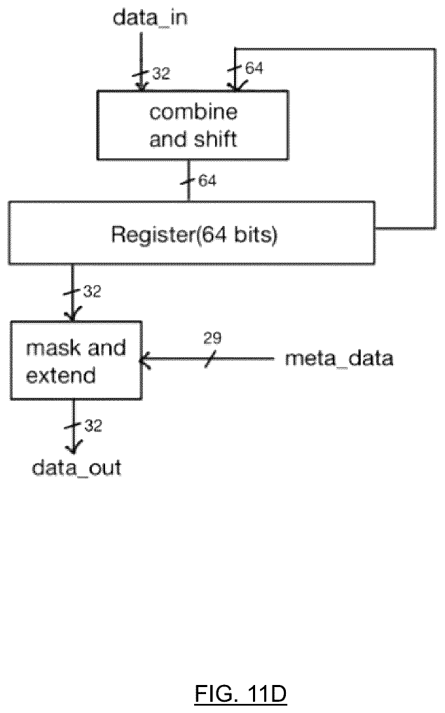

For the compressor, FIG. 11A shows an example of a compressor that contains 8 packer units (FIG. 11C). The compressor accepts one row (8 numbers) per cycle, for a total of 8 cycles to consume the whole group. Each column is treated as a subgroup whose exponents are to be encoded using the first element's exponent as the base and the rest as deltas. Accordingly, the exponents of the first row are stored as-is via the packers. For every subsequent row, the compressor first calculates deltas prior to passing them to the packers.

The length of the mantissa is the same for all values and is provided by the mantissa quantizer method, for example, via Quantum Mantissa or BitChop. Each row uses a container whose bitlength is the sum of the mantissa bitlength plus the bitlength needed to store the highest exponent magnitude across the row. To avoid wide crossbars when packing/unpacking, values remain within the confines of their original format bit positions. In contrast to other approaches, every row can use a different bitlength, the values are floating-point, the bitlengths vary during runtime and per row, and training is targeted. The exponent lengths can be stored as metadata per row. These can be stored separately in which case two write streams per tensor are used; both however are generally sequential and thus DRAM-friendly. The mantissa lengths can be either tensor/layer, or network-wide, and can be stored along with the other metadata for the model.

Each packer (FIG. 11C) can take a single FP32 number in [exponent, sign, mantissa] format, mask out unused exponent and mantissa bits, and rotate the remaining bits to position to fill in the output row. The mask can be created based on the exp_width and man_width inputs. The rotation counter register provides the rotation count which can be updated to (exp_width+man_width+1) every cycle. The (L,R) register pair, can be used to tightly pack the encoded values into successive rows; which may be needed since a value may now be split across two memory rows when either register 32b (or 16b for BFloat16) are drained to memory. This arrangement effectively packs the values belonging to this column tightly within a column of 32b in memory. Since each row has the same total bitlength, the 8 packers operate in tandem filling their respective outputs at the same rate. As a result, the compressor produces 8×32b at a time. The rate at which the outputs are produced depends on the compression rate achieved, the higher the compression, the lower the rate.

As FIG. 11B shows, the decompressor mirrors the compressor. It takes 8 3-bit exponent widths and a mantissa length, and processes 8×32 bits of data per cycle. Every column of 32b is fed into a dedicated unpacker per column. The unpacker (FIG. 11d) reads the exponent length for this row and the global mantissa length, takes the correct number of bits, and extends the data to [exponent, sign, mantissa] format.

Each unpacker handles one column of 32b from the incoming compressed stream. The combine-and-shift will combine the input data and previous data in register then shift to the left. The number of shifted bits is determined by the exponent and mantissa lengths of this row. The 32-bit data on the left of the register are taken out and shifted to the right (zero extending the exponent). Finally, the unpacker reinserts the mantissa bits that were trimmed during compression. Since each row of data uses the same total bitlength, the unpackers operate in tandem consuming data at the same rate. The net effect is that external memory sees wide accesses on both sides.

TABLE 1

| | FP32 | | BF16 | SFPQM | | SFPBC | |
|---|---|---|---|---|---|---|---|
| Network | Accuracy | Footprint | Footprint | Accuracy | Footprint | Accuracy | Footprint |
| ResNet18 | 69.94 | 100% | 50% | 69.54 | 14.70% | 69.95 | 23.70% |
| MobileNet | 65.6 | 100% | 50% | 65.26 | 24.90% | 65.21 | 27.20% |
| V3 Small | | | | | | | |

TABLE 2

| | Performance | | | Energy Efficiency | | |
|---|---|---|---|---|---|---|
| Network | BFloat16 | SFPQM | SFPBC | BFloat16 | SFPQM | SFPBC |
| ResNet18 | 1.53x | 2.30x | 2.09x | 2.00x | 6.12x | 4.22x |
| MobileNet V3 | 1.72x | 2.37x | 2.14x | 2.00x | 3.95x | 3.60x |
| Small | | | | | | |

TABLE 1 shows SFP_{BC}, SFP_{QM}, BF16 accuracy and total memory reduction versus FP32. TABLE 2 shows performance and energy efficiency gains in comparison with the FP32 baseline; where higher is better.

For some models and training algorithm configurations, full precision values are needed during the backward pass. Storing the values in full precision using the above described Gecko approach would generally reduce traffic only for the exponents and not for the mantissas. Fortunately, encoder and decoder designs can be adapted to support full precision values while achieving reduced traffic for both the exponents and the mantissas. This can be accomplished by encoding values in two streams, one containing the encoded exponents and the trimmed mantissas, and another containing the least significant mantissa bits. The first stream is encoded and decoded as described herein. The second stream contains the mantissa bits that would have been discarded by the encoder described herein.

For example, and for clarity, assume a floating-point format where the mantissa is 8b and consider a tensor of four values whose mantissas as (0x82, 0x13, 0x05, 0xAC) written in hexadecimal. Here the exponents are omitted for clarity. Assuming that mantissa control, such as using Quantum Mantissa of BitChop, instructs Gecko to keep only the upper 4 bits of these mantissas. The encoder would generate one stream containing only the upper four bits (0x8, 0x1, 0x0, 0xA) and discard the four least significant bits from each mantissa value. In the modified embodiment, Gecko, as before, would generate a first stream containing the upper bits only (0x8, 0x1, 0x0, 0xA) and also a second stream containing the remaining 4 bits per mantissa (0x2, 0x3, 0x5, 0xC). The streams can be generated concurrently as Gecko is encoding the incoming values. The streams can be written in parallel to memory and both streams can be sequential. For all operations that require only the upper bits, this encoding enables the decoders to read only the upper bits per value by accessing only the first stream. This approach results in reduced traffic when reading the values; which is the case for most operations. For operations where the full precision mantissas are required, such as weight updates, Gecko can fetch both streams in tandem; appending the least significant bits per value, as read from the second stream, with the most significant bits, as read from the first stream. Both streams can be written and read sequentially, and thus, are memory friendly.

For some models, fixed-point inference is possible. One way to train for fixed-point inference is by representing the activations in fixed point during training and to use integer arithmetic during the forward pass. To demonstrate that the present embodiments remain effective, Quantum Mantissa can be updated to operate on fixed-point values and used during training with fixed-point activations. The footprint reduction and accuracy effect of the resulting Quantum Integer are shown in the results with ResNet18 on ImageNet in TABLE 3. This simple, yet effective, modification is able to learn the per-tensor optimal bitlengths for uniform quantization training with minimal accuracy cost. This is also a good choice for training when there is confidence that the task the network is solving can be performed in low bitlength fixed-point. The Quantum Integer behavior is generally similar to Quantum Mantissa throughout training.

TABLE 3

| | |
|---|---|
| FP32 | Quantum Integer |

| Network | Accuracy | Accuracy | Footprint Reduction |
|---|---|---|---|
| ResNet18 | 69.94 | 69.15 | 6.21x |

The example experiments studied two variants of the present embodiments: GeckoQuantum Mantissa (SFP_{QM}) and GeckdBitChop (SFP_{BC}), which are combinations of the exponent and mantissa compression approaches. These experiments used sparsity encoding only for those tensors where doing so reduces footprint, avoiding the increase in traffic that would occur otherwise. This is especially useful for MobileNet V3 that does not use ReLU. Full training runs were performed for ResNet18 and MobileNet V3 Small over ImageNet using an RTX3090/24 GB while using PyTorch v1.10. Quantum Mantissa was implemented by modifying the loss function and adding the gradient calculations for the per tensor/layer parameters; where BitChop was simulated in software. For both approaches, mantissa bitlength effects were simulated by truncating the mantissa bits at the boundary of each layer using PyTorch hooks and custom layers. Gecko was implemented in software via PyTorch hooks. The above enhancements allow measuring the effects of the present embodiments on traffic and model accuracy.

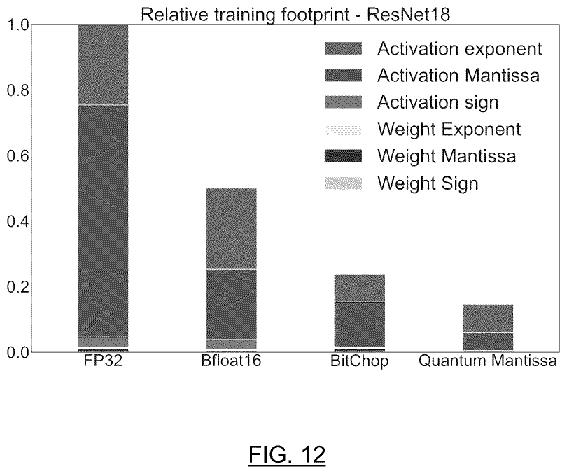

The example experiments determined activation and weight footprint reduction on ResNet18. Combined, the compression techniques excel at reducing memory footprint during training with little effect on accuracy. TABLE 1 shows the cumulative total memory reduction in comparison with FP32 and BFloat16 baselines and the corresponding validation accuracies. The compression approaches of the present embodiments significantly reduce memory footprint for all tested networks, whilst not significantly affecting accuracy. SFP_{QM}. FIG. 12 shows the relative footprint of each part of the datatype with SFP_{QM} in comparison with the FP32 and Bfloat16 baseline. Even though the present methods are very effective at reducing the weight footprint (91% for mantissas and 54% for exponents), this effect is negligible in the grand scheme of things due to Amdhal's law and the fact that weights are a very small part of all three footprints. For the same reason, the reductions in activation footprint (92% for mantissas, 63% for exponents and 98% for sign) have a far greater effect. Because of the effectiveness of Quantum Mantissa mantissa compression, the mantissas are reduced from the top contributor in FP32 (70%), to a minor contributor (38%). While exponents are significantly reduced too, they start to dominate with 59% of the footprint in comparison with the FP32 baseline at 24%. Similar conclusions are reached when comparing with Bfloat16 except for the fact that in Bfloat16 mantissas and exponents have similar footprint.

FIG. 12 also shows the relative footprint of the datatype components under SFP_{BC} when compared to the FP32 and Bfloat16 baselines. While BitChop does not generally reduce mantissa bitlength for the network's weights, this does not have a great effect in the total memory footprint reduction due to the small size of weights in comparison to activations. Although mantissa weight footprint is not reduced, weight exponent footprint is reduced by 56%. Accordingly, focus on the activations' mantissa bitlengths yields a significant total memory footprint reduction in comparison to FP32 (mantissa footprint is reduced by 81%, exponent footprint by 63% and sign by 98% in activations), and a smaller but still significant reduction in comparison to Bfloat16 (36% for mantissa and 63% for exponents).

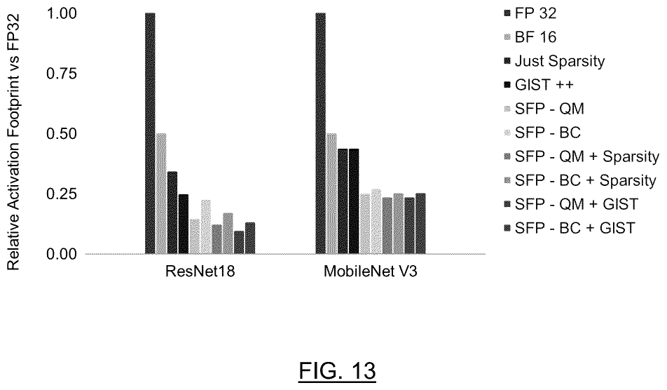

FIG. 13 illustrates the compression scheme of the present embodiments compared against Bfloat16, GIST++ and JS (JS uses an extra bit per value to avoid storing zeros). The comparison was limited to activations. All approaches benefited from the use of a 16 bit base. ResNet18, JS and GIST++ benefitted from the 30% reduction due to high sparsity induced by ReLu. GIST++ benefitted even further because of its efficient compression of maximum pooling. SFP_{BC} does even better just by finding a smaller datatype and outperforming all of the comparisons; whereas SFP_{QM} proved even better by adjusting the datatype per layer. When combined, this further improves compression ratios to 10× and 8× for modified SFP_{QM} and SFP_{BC}, respectively.

Performance improvements of Bfloat16, SFP_{QM}, and SFP_{BC} over the FP32 baseline are shown in TABLE 2. On average, SFP_{QM} and SFP_{BC} produced a speed up of 2.3× and 2.1× respectively, while Blfoat 16 speeds up by 1.6×. Both SFP_{QM} and SFP_{BC} significantly outperform both the FP32 baseline and Bfloat 16 on all networks. However, performance does not scale linearly even though SFP_{QM} and SFP_{BC} reduce the memory footprint to 14.7% and 23.7% respectively. This is due to layers that were previously memory bound during the training process now becoming compute bound because of the reduction in memory footprint. This is also the reason why even though Bfloat16 reduces the data type to half, it does not achieve 2× speedup. This transition of most layers from memory bound to compute bound also affects the improvements in performance that SFP_{QM} can offer, as even though the method consistently achieves a lower footprint than SFP_{BC}, this only offers an advantage for performance in the few layers that remain memory bound. SFP_{QM} may offer bigger performance benefits if coupled with higher computational performance hardware that would reduce the computation time of the layers. Regardless, while a reduction in traffic may not yield a direct improvement in performance, it does improve energy efficiency.

TABLE 2 also shows the improvement in energy efficiency of Bfloat16, SFP_{QM} and SFP_{BC} over the FP32 baseline. SFP_{QM} and SFP_{BC} excel at improving energy efficiency by significantly reducing DRAM traffic. The energy consumption of DRAM accesses greatly outclasses that of computation, and due to DRAM accesses not being limited by compute bound network layers, SFP_{QM} and SFP_{BC} are more impactful in energy efficiency than in performance improvements, achieving an average of 5.0× and 3.9× energy efficiency improvements, respectively. The dominance of DRAM access energy consumption over computation can also be seen in Bfloat16, where the reduction to half the footprint, the use of 16-bit compute units and the compute layers being no longer a limiting factor gives Bfloat16 a 2× energy efficiency improvement.

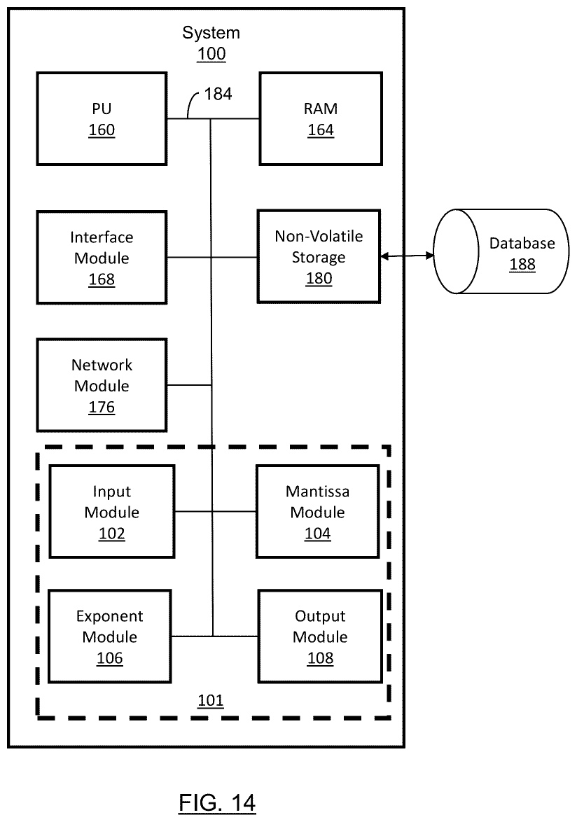

FIG. 14 illustrates a schematic diagram of a system 100 for adaptation of training data for training of a machine learning model, according to various embodiments. As shown, the system 100 has a number of physical and logical components, including a processing unit (“PU”) 160, random access memory (“RAM”) 164, an interface module 168, a network module 176, non-volatile storage 180, and a local bus 184 enabling PU 160 to communicate with the other components. PU 160 can include one or more central processing units, one or more graphical processing units, microprocessors, dedicated hardware, or other integrated processing circuits. RAM 264 provides relatively responsive volatile storage to PU 260. The interface module 168 enables input to be provided; for example, directly via a user input device, or communicated indirectly, for example, via an external device or system. The interface module 168 also enables output to be provided; for example, directly via a user display, or indirectly, for example, communicated over the network module 176. The network module 176 permits communication with other systems or computing devices; for example, over a local area network or over the Internet. Non-volatile storage 180 can store an operating system and programs, including computer-executable instructions for implementing the methods described herein, as well as any derivative or related data. In some cases, this data can be stored in a database 188. In some cases, during operation of the system 100, the operating system, the programs and the data may be retrieved from the non-volatile storage 280 and placed in RAM 264 to facilitate execution. In other embodiments, any operating system, programs, or instructions can be executed in hardware, specialized microprocessors, logic arrays, or the like. While FIG. 14 illustrates a system implemented on a single computing device, it is understood that the processing, or any of the functions undertaken by the system 100, can be distributed over multiple computing devices; for example, in a cloud or distributed computing environment.

In an embodiment, the PU 160 can be configured to execute a number of conceptual modules 101; for example, an input module 102, a mantissa module 104, an exponent module 106, and an output module 108. In further cases, functions of the above modules can be combined or executed on other modules. In some cases, functions of the above modules can be executed on remote computing devices, such as centralized servers and cloud computing resources communicating over the network module 176.

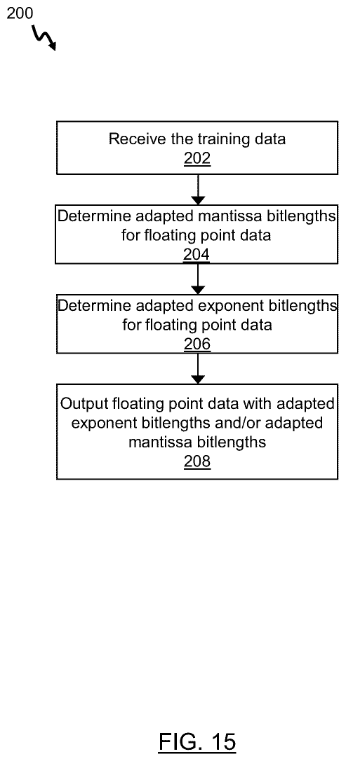

FIG. 15 illustrates a flowchart of a method 200 for adaptation of training data for training of a machine learning model, according to an embodiment. The training data comprises floating point data and is used for training of the machine learning model.

At block 202, the input module 102 receives the training data for training the machine learning model from the database 188, interface module 168, or the network module 176.

At block 204, the mantissa module 104 determines adapted mantissa bitlengths for the floating point data used to store activations or weights of the training data. At block 206, in some cases, the exponent module 106 determines adapted exponent bitlengths for the floating point data used to store activations or weights of the training data. As described herein, the adapted mantissa bit lengths are determined independent of the bit lengths for the adapted exponents. In some cases, the adapted exponent bitlengths can be determined by learning bitlengths for floating point data and limiting the bitlengths accordingly.

At block 208, the output module 108 outputs or stores the floating point data with the adapted mantissas, the adapted exponent bitlengths, or both, for training the machine learning model, to the database 188, the interface module 168, or the network module 176.

The present embodiments provide approaches that dynamically adapt the bitlengths and containers used for floating-point values during training. The different distributions of the exponents and mantissas provides tailored approaches for each. The largest contributors were to off-chip traffic during training activations and also the weights. The example experiments demonstrate that the methods are effective. Substantial advantages include, at least, that the present embodiments: 1) are dynamic and adaptive, 2) do not modify the training algorithm, and 3) take advantage of value content for the exponents.

Although the invention has been described with reference to certain specific embodiments, various modifications thereof will be apparent to those skilled in the art without departing from the spirit and scope of the invention as outlined in the claims appended hereto.

1. A computer-implemented method for adaptation for data of a machine learning model, the data of the machine learning model comprising floating point data, and a training dataset, the method comprising:
receiving the training dataset for training the machine learning model;
determining adapted mantissa bitlengths for the floating point data used to store activations or weights of the model, the adapted mantissa bitlengths being determined independent of the bitlengths of exponents of the floating point data; and
storing the floating point data with the adapted mantissas for training the machine learning model.

2. The method of claim 1, wherein determining adapted mantissa bitlengths comprises determining integer mantissa bitlengths in a forward pass of training of the machine learning model and determining integer mantissa bitlengths and non-integer mantissa bitlengths in the backward pass of training of the machine learning model.

3. The method of claim 2, wherein the training comprises gradient descent.

4. The method of claim 2, wherein determining the integer mantissa bitlengths comprises integer quantization of the mantissa by removing all but a top predetermined number of bits.

5. The method of claim 2, wherein the machine learning model comprises a modified loss function that penalizes mantissa bitlengths by adding a weighted average of bits required for weights and activations of the mantissa bitlengths.

6. The method of claim 1, wherein determining adapted mantissa bitlengths comprises splitting training into a plurality of conceptual periods and adjusting the mantissa bitlengths at the end of each period based on network progress in the preceding period.

7. The method of claim 6, wherein the network progress is determined using an exponential moving average of a training loss over the preceding period.

8. The method of claim 7, wherein the mantissa bitlength is reduced if the training loss is less than the exponential moving average, the mantissa bitlength is maintained if the training loss is equal to the exponential moving average, and the mantissa bitlength is increased if the training loss is greater than the exponential moving average.

9. The method of claim 1, further comprising determining adapted exponent bitlengths for floating point data used to store activations or weights of the model's data, the adapted exponent bitlengths are determined independent of the determination of the adapted mantissa bitlengths of the floating point data, and further comprising storing the floating point data with the adapted exponent bitlengths for training the machine learning model.

10. The method of claim 9, wherein determining the adapted exponent bitlengths comprises grouping the exponents of the floating point data and determining the adapted exponent bitlengths for each group comprises determining differences from a base exponent value per group.

11. The method of claim 10, wherein the base exponent value is a first value of the group or a fixed pre-determined number.

12. The method of claim 11, wherein the adapted exponent bitlengths for each group comprise a number of bits to store a largest difference to the base exponent value in the group.

13. The method of claim 1, further comprising learning exponent bitlengths for floating point data of the model during forward passes and backward passes of training using gradient descent, and limiting the exponent bitlengths to the learned bitlengths.

14. A system for adaptation of data of a machine learning model, the data of the machine learning model comprising floating point data, and a training dataset, the system comprising one or more processors and a data storage, the one or more processors configurable to execute:
an input module to receive the training dataset for training the machine learning model;
a mantissa module to determine adapted mantissa bitlengths for the floating point data used to store activations or weights of the model data, the adapted mantissa bitlengths being determined independent of the bitlengths of the exponents of the floating point data; and
an output module to store the floating point data with the adapted mantissas for training the machine learning model.

15. The system of claim 14, wherein determining adapted mantissa bitlengths comprises determining integer mantissa bitlengths in a forward pass of training of the machine learning model and determining integer mantissa bitlengths and non-integer mantissa bitlengths in the backward pass of training of the machine learning model.

16. The system of claim 15, wherein the training comprises gradient descent.

17. The system of claim 15, wherein determining the integer mantissa bitlengths comprises integer quantization of the mantissa by removing all but a top predetermined number of bits.

18. The system of claim 15, wherein the machine learning model comprises a modified loss function that penalizes mantissa bitlengths by adding a weighted average of bits required for weights and activations of the mantissa bitlengths.

19. The system of claim 14, wherein determining adapted mantissa bitlengths comprises splitting training into a plurality of conceptual periods and adjusting the mantissa bitlengths at the end of each period based on network progress in the preceding period.

20. The system of claim 19, wherein the network progress is determined using an exponential moving average of a training loss over the preceding period.

21. The system of claim 10, wherein the mantissa bitlength is reduced if the training loss is less than the exponential moving average, the mantissa bitlength is maintained if the training loss is equal to the exponential moving average, and the mantissa bitlength is increased if the training loss is greater than the exponential moving average.

22. The system of claim 14, further comprising an exponent module to determine adapted exponent bitlengths for floating point containers used to store activations or weights of the model's data, the adapted exponent bitlengths are determined independent of the determination of the adapted mantissa bitlengths of the floating point data, and wherein the output module further stores the floating point data with the adapted exponent bitlengths for training the machine learning model.

23. The system of claim 14, wherein determining the adapted exponent bitlengths comprises grouping the exponents of the floating point containers and determining the adapted exponent bitlengths for each group comprises determining differences from a base exponent value per group.

24. The system of claim 23, wherein the base exponent value is a first value of the group or a fixed pre-determined number.

25. The system of claim 24, wherein the adapted exponent bitlengths for each group comprise a number of bits to store a largest difference to the base exponent value in the group.

26. The system of claim 14, further comprising an exponent module to learn exponent bitlengths for floating point data of the model during forward passes and backward passes of training using gradient descent, and limiting the exponent bitlengths to the learned bitlengths.

27. A computer-implemented method for training a machine learning model using a training dataset, the method comprising:
receiving the training data;
transforming the machine learning model's floating point data to have adapted bitlengths for mantissa, exponent, or both, to produce a transformed model;
storing the adapted bitlengths for the machine learning model;
training the transformed machine learning model with the training dataset.

28. The method of claim 27, wherein a previously trained machine learning model is retrained with a second training dataset, and wherein the retraining is performed by transforming the model to have floating point data transformed with the adapted bitlengths.

29. The method of claim 27 wherein the adapted bitlengths are permitted to vary for each layer and tensor of the machine learning model.

30. A computer-implemented method for adaptation of a machine learning model's data, the model's data comprising fixed point data, and a training dataset, the method comprising:
receiving the training data for training the machine learning model;
determining adapted bitlengths for the fixed point data used to store activations or weights of the model's data; and
storing the fixed point data with the adapted mantissas while training the machine learning model.
